(19) United States
(12) Patent Application Publication
(10) Pub. No.: US 2016/0281598 A1
(43) Pub. Date: Sep. 29, 2016

(54) MULTI-JOINT CRANK DRIVE OF AN INTERNAL COMBUSTION ENGINE AND METHOD FOR OPERATING A MULTI-JOINT CRANK DRIVE

(71) Applicant: AUDI AG, Ingolstadt (DE)

(72) Inventors: MATTHIAS BRENDEL, Ingolstadt (DE); MARKUS MEYER, Mildenau (DE)

(73) Assignee: AUDI AG, Ingolstadt (DE)

(21) Appl. No.: 15/036,650

(22) PCT Filed: Nov. 13, 2014
(86) PCT No.: PCT/EP2014/003037

§ 371 Date: May 13, 2016

(30) Foreign Application Priority Data
Nov. 14, 2013 (DE) 102013019214.5

(51) Int. Cl. F02B 75/04; F02B 41/04

(52) U.S. Cl. CPC F02B 75/048; F02B 41/04

(57) ABSTRACT

A multi-joint crank drive of an internal combustion engine, comprising a plurality of coupling members rotatably supported on crank pins of a crankshaft and a plurality of articulation connecting rods rotatably supported on crank pins of an eccentric shaft, wherein each of the coupling members is pivotably connected to a piston connecting rod of a piston of the internal combustion engine and to one of the articulation connecting rods. In order to reduce second order inertia forces, the multi-joint crank drive is designed or adjusted in such a way that a crankshaft rotational angle range of an intake phase is greater than 180 degrees; a crankshaft rotational angle range of a compression phase is less than 180 degrees; a crankshaft rotational angle range of an expansion phase is greater than 180 degrees; and a crankshaft rotational angle range of an exhaust phase is less than 180 degrees.

The invention relates to a multi-joint crank drive of an internal combustion engine with a plurality of coupling members rotatably supported on crankpins of a crankshaft, and a plurality of articulated connecting rods rotatably supported on crankpins of an eccentric shaft, wherein each of the coupling members is pivotally connected with a piston connecting rod of a piston of the internal combustion engine and one of the articulated connecting rods. The invention also relates to a method for operating such a multi-joint crank drive.

The multi-joint crank drive of the above-mentioned type is for example part of the internal combustion engine but can also be used in other areas. The multi-joint crank drive includes the eccentric shaft, whose rotation angle can preferably be adjusted by means of an actuator, in particular in dependence of an operating point of the internal combustion engine. As an alternative the eccentric shaft can also be operatively connected with a crankshaft of the internal combustion engine and in this way be driven by the internal combustion engine. The multi-joint crank drive includes a number of coupling members that corresponds to the number of the pistons of the internal combustion engine, which coupling members are each rotatably supported on the corresponding crankpin of the crankshaft and have two arms that protrude to opposite sides over the crankshaft and which are provided at their ends with a pivot joint.

One of the pivot joints serves for pivotal connection with the piston connecting rod, which connects a piston of the internal combustion engine with the crankshaft via the coupling member. Another one of the pivot joints serves for pivotal connection with the so-called articulated connecting rod, which is rotatably supported with its other end on the crankpin of the eccentric shaft. For this purpose the articulated connecting rod preferably has the two conrod eyes. The first conrod eye is part of the pivot joint via which the articulated connecting rod interacts with the coupling member. The first conrod eye includes for example a coupling pin, preferably a bearing pin, which is held on the coupling member. The second conrod eye, in analogy thereto, is part of the pivot joint via which the articulated connecting rod is connected with the eccentric shaft. In particular the second conrod eye engages about at least a region of the crankpin of the eccentric shaft.

By means of the multi-joint crank drive the compression ratio achieved in one of cylinders that is assigned to the respective piston can be adjusted, in particular in dependence of the operating point of the internal combustion engine and/or the actual operating cycle. For adjusting the compression ratio the eccentric shaft is brought into a rotary angular position that corresponds to the desired compression ratio, or the phase position between the eccentric shaft and the crankshaft is adjusted to assume a defined value. In normal crank drives for internal combustion engines, due to the finite length of the piston connecting rod or a connecting rod body of the piston connecting rod, the value of the piston acceleration at an upper dead center position of the piston is higher than at a lower dead center position of the piston. When using the crank drive for example for an internal combustion engine constructed as a in-line internal combustion engine with 180 degree crank angle of the crankshaft, this results in a non compensated second order inertia. This adversely affects the smooth running of the internal combustion engine.

From the state of the art for example the patent publication DE 10 2012 008 244 A1 is known. This reference relates to a multi-joint crank drive of an internal combustion engine which is configured or adjusted for reducing second order inertia forces so that a crankshaft rotary angular range of an intake phase is smaller than 180 degrees; a crankshaft rotary angular range of a compression phase is greater than 180 degrees; a crankshaft rotary angular range of an expansion phase is smaller than 180 degrees; and a crankshaft rotary angular range of a exhaust phase is greater than 180 degrees. Further the state of the art includes the documents EP 2 053 217 A2 and EP 2 119 890 A1.

It is an object of the invention to present a multi-joint crank drive, which does not have the above mentioned disadvantage but in particular reduces the intensity of the second order inertia forces compared to a normal crank drive.

According to the invention this is achieved with a multi-join crank drive with the features of claim 1. Hereby it is provided that for reducing second order inertia forces the multi-join crank drive is configured or adjusted so that a crankshaft rotary angular range of an intake phase is greater than 180; that a crankshaft rotary angular range of a compression phase is smaller than 180; that a crankshaft rotary angular range of an expansion phase is greater than 180; and that a crankshaft rotary angular range of an exhaust phase is smaller than 180. The intake phase, the compression phase and the exhaust phase directly follow each other and are in particular assigned to a piston lifting curve, which describes the position of the piston over the crankshaft angle.

The intake phase of the piston lifting curve extends hereby from a crankshaft angle present at an upper dead center position, which is given during a charge-cycle (charge-cycle-OT; LOT) until a crankshaft angle present at a lower dead center position during the charge-cycle (charge-cycle-UT; LUT). The compression phase of the piston lifting curve extends, starting from the charge-cycle-UT, until the upper charge-cycle, which is present in the range of an ignition (ignition-OT); ZOT). The expansion phase of the piston lifting curve extends from this ignition-OT to a crankshaft angle which is present at a lower dead center position (ignition-UT; ZUT), which follows the ignition. The exhaust phase of the piston lifting curve extends from the ignition-UT to the above-mentioned charge-cycle-OT.

In a normal crank drive the crankshaft rotary angular ranges for the mentioned phases are respectively exactly 180 degrees. Due to the configuration or adjustment of the multi-joint crank drive to the above-described parameters, the piston speed of the at least one piston of the internal combustion engine decreases slightly in a crankshaft rotary angular range in at least one crankshaft angular range, in particular the crankshaft angular range of about 270 degrees and/or 630 degrees relative to the piston speed of the normal crankshaft drive. Hereby the ranges extend for example about the mentioned crankshaft rotary angle by at least ±5 degrees, at least ±10 degrees, at least ±15 degrees, at least ±20 degrees, at least ±25 degrees, at least ±30 degrees, at least ±35 degrees, at least ±40 degrees or at least ±45 degrees.

The inflection points in a speed course of the piston plotted over the crankshaft angle are shifted to lower crankshaft angles so that the piston acceleration overall approximates a cosine course. As a result of the thus achieved approximation of the piston accelerations in the upper dead center position and the lower dead center position, the second order inertia forces are significantly reduced relative to the normal crankshaft drive. Correspondingly smaller second order forces are generated during a lift of the piston than in the normal crankshaft drive with the same overall lift. In addition thermodynamic advantages are realized by the prolonged intake phase, which causes a reduction of the charge-cycle losses, and the shortened compression phase, which reduces the knocking tendency by shortening the time period during which the mixture is under high pressure and high temperature. The prolonged expansion phase enables a better energy conversion and a more efficient use of the combustion pressure.

A preferred embodiment of the invention provides that a rotation axis of the eccentric shaft is situated above the plane, which receives a rotation axis of the crankshaft and is perpendicular to at least one cylinder longitudinal middle axis. The plane is thus defined by the rotation axis of the crankshaft and the cylinder longitudinal center axis. In longitudinal direction of the internal combustion engine—in relation to the rotation axis of the crankshaft—the plane has the same position and direction as this rotation axis. At the same time it is perpendicular to the at least one cylinder longitudinal center axis, so that the cylinder longitudinal center axis is positioned normal in relation to the plane.

The cylinder longitudinal center axis is assigned to a cylinder of the internal combustion engine and extends in the longitudinal direction of the cylinder. The cylinder longitudinal center axis is hereby for example positioned along the longitudinal extent of the cylinder in its center point. Of course the plane can also be perpendicular to multiple cylinder longitudinal center axes of multiple cylinders of the internal combustion engine, particularly preferably perpendicular to the cylinder longitudinal center axes of all cylinders of the internal combustion engine. The eccentric shaft is arranged so that its rotation axis is arranged above this plane. Particularly preferably the entire eccentric shaft, i.e., not only its rotation axis, is situated above this plane. For example the rotation axis of the eccentric shaft is arranged directly adjacent the plane, i.e., it adjoins this plane. As an alternative the entire eccentric shaft is arranged directly adjacent the plane, i.e., it adjoins this plane. However, it can also be provided that the rotation axis of the eccentric shaft or the entire eccentric shaft is arranged above the plane and is additionally spaced-apart from the plane.

A further embodiment of the invention provides that the crankshaft has a crank angle of 180 degrees. For example the internal combustion engine, which is assigned the multi-joint crank drive, is configured as four-cylinder internal combustion engine. It is only important that the crankshaft has a crank angle of 180 degrees. Of course a crank angle different from this value can also be realized. Of course a number of cylinders other than four can be provided, for example two, three, five, six, eight or twelve cylinders, wherein the crank angle is preferably adjusted.

A particularly preferred embodiment of the invention provides that in the intake phase an upper dead center position (charge-cycle-OT) is present at a crankshaft angle of greater than 0 degrees and at most 4 degrees, in particular of at least 2 degrees and at most 3 degrees, preferably of at least 2.4 degrees and at most 2.7 degrees. In addition or as an alternative it can be provided that in the compression phase a lower dead center position (charge-cycle-UT) is present at a crankshaft angle of greater than 180 degrees, in particular a crankshaft angle of at least 18 degrees or at least 186 degrees and at most 190 degrees, at most 189 degrees or at most 188 degrees, particularly preferably of at least 186.9 degrees up to at most 187.2 degrees. The crankshaft angle can thus be within a range from 185 degrees to 188 degrees, 189 degrees or 190 degrees. It can also be in the range of 186 degrees to at most 188 degrees, 198 degrees or 190 degrees.

An embodiment of the invention provides that in the expansion phase an upper dead center position (ignition-OT) is present at a crankshaft angle of greater than 360 degrees and at most 364 degrees, in particular of at least 362 degrees and at most 363 degrees, preferably of at least 362.4 degrees and at most 362.7 degrees. In addition or as an alternative it can be provided that in the exhaust phase a lower dead center position (ignition-UT) is present at a crankshaft angle of greater than 540 degrees, in particular at a crankshaft angle of at least 545 degrees or at least 546 degrees and at most 550 degrees, at most 549 degrees or at most 548 degrees, particularly preferably of at least 546.9 degrees to at most 547.2 degrees. The crankshaft angle is thus for example in the range of 545 degrees to 548 degrees, 549 degrees or 550 degrees. However, it can also be in the range of 546 degrees to 548 degrees, 549 degrees or 550 degrees.

Finally it can be provided that the crankshaft in the angular range of the intake phase and compression phase (charge-cycle-OT to ignition-OT) and/or the crankshaft angular ranges of the expansion phase and exhaust phase (ignition-OT to charge-cycle-OT) are in sum equal to 360 degrees.

For example it is provided that the crankshaft angular difference between the charge-cycle-OT and the charge-cycle-UT is 184.5 degrees. In addition or as an alternative the crankshaft angular difference between the charge-cycle-UT and the ignition-OT can be 175.5 degrees. A further embodiment of the invention provides that the crankshaft angular difference between the ignition-OT and the ignition-UT is 184.5 degrees. In addition or as an alternative it is possible that the crankshaft angular difference between the ignition-UT and the charge-cycle-OT is 175.5 degrees.

The invention also relates to a method for operating a multi-joint crankshaft drive of an internal combustion engine, in particular a multi-joint crank drive according to the description above, wherein the multi-joint crank drive has a plurality of coupling members that are rotatably supported on crankpins of a crankshaft and a plurality of articulated connecting rods which are rotatably supported on crankpins of an eccentric shaft, wherein each of the coupling members is pivotally connected with a piston connecting rod of a piston of the internal combustion engine and one of the articulated connecting rods. Hereby it is provided that for reducing second order free inertia forces, the multi-joint crankshaft drive is adjusted in at least one operating mode so that a crankshaft rotary angular range of an intake phase corresponds to a first value, which is greater than 180 degrees, that a crankshaft rotary angular range of a compression phase corresponds to a second value, which is smaller than 180 degrees, that a crankshaft rotary angular range of an expansion phase corresponds to a third value, which is greater than 180 degrees and that a crankshaft rotary angular range of an exhaust phase corresponds to a fourth value, which is smaller than 180 degrees. The advantages of such an approach or such a configuration of the multi-joint crank drive have already been discussed above. The method as well as the multi-joint crank drive can be modified according the description above so that reference is made thereto.

In a further embodiment of the invention it is provided that in at least one operating mode the multi-joint crank drive is adjusted so that the crankshaft rotary angular range of the intake phase is different from the first value, in particular equal to 180 degrees, and/or that the crankshaft rotary angular range of the compression phase is different from the second value, in particular equal to 180, and/or that the crankshaft rotary angular range of the expansion phase is different from the third value, in particular equal to 180 degrees, and/or that the crankshaft rotary angular range of the exhaust phase is different from the fourth value, in particular equal to 180 degrees.

It is also provided to adjust the multi-joint crank drive in different ways. Hereby in the at least one first operating mode the crankshaft rotary angular ranges of the individual phases are different from 180 degrees. In the second operating mode on the other hand at least one of the crankshaft rotary angular ranges is selected to be different from the above-mentioned value. Hereby the at least one of the crankshaft rotary angular ranges can for example also be equal to 180 degrees.

During operation of the multi-joint crank drive or the internal combustion engine, the crankshaft rotary angular range is thus always selected so that an optimal operation of the internal combustion engine is realized. The actual operating mode set at the multi-joint crank drive can correspondingly be selected from the at least one operating mode and the at least one further operating mode, for example in dependence on an operating state of the internal combustion engine and/or at least one operating parameter of the internal combustion engine.

In the following, the invention is explained in more detail by way of embodiments shown in the drawing without limiting the invention. Herby it is shown in:

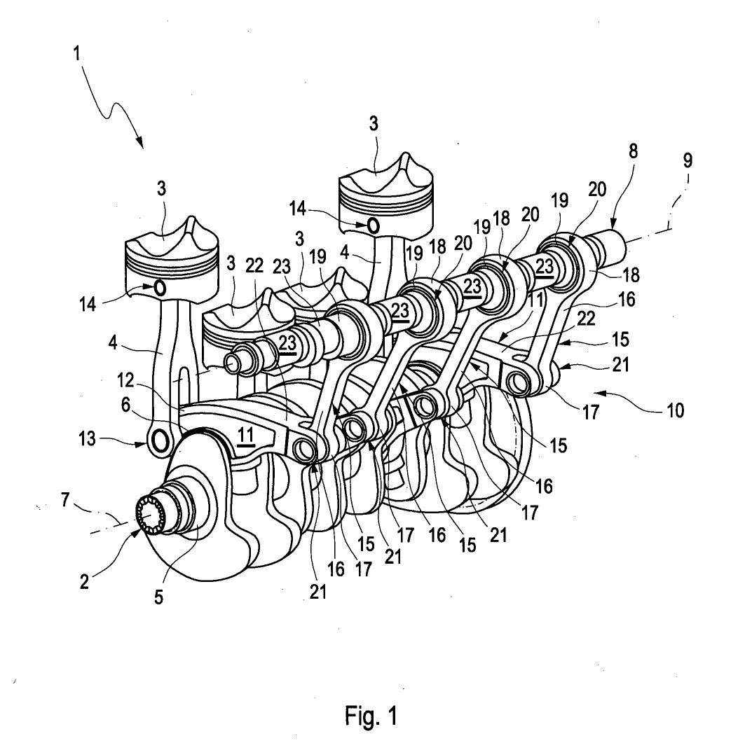

FIG. 1 a region of a multi-joint crank drive of an internal combustion engine,

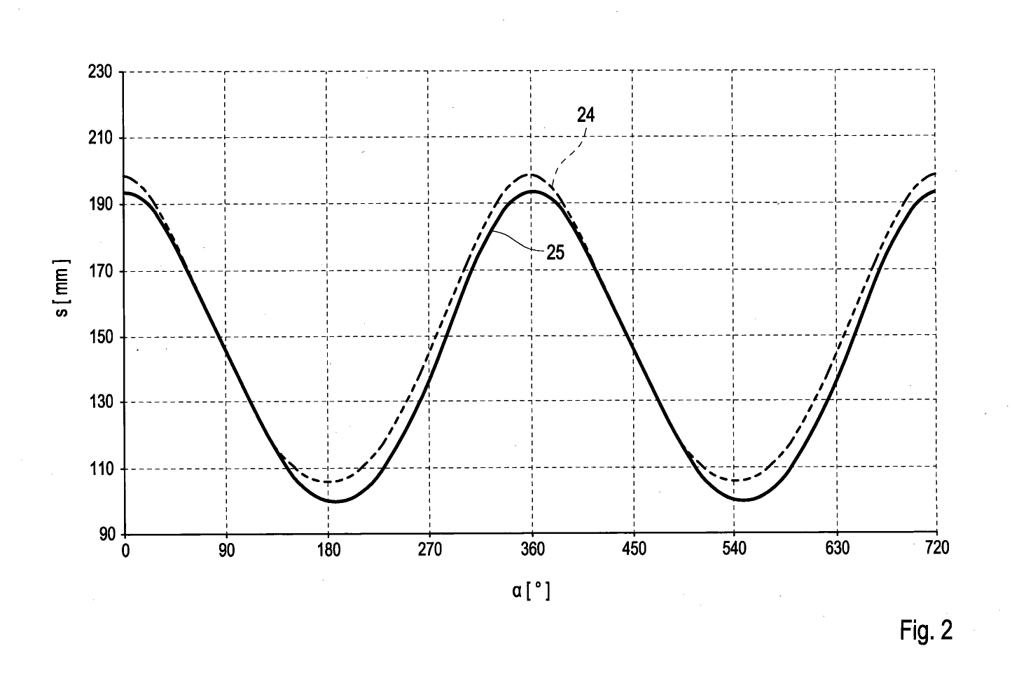

FIG. 2 a diagram in which courses of a piston lift are plotted over a crankshaft angle,

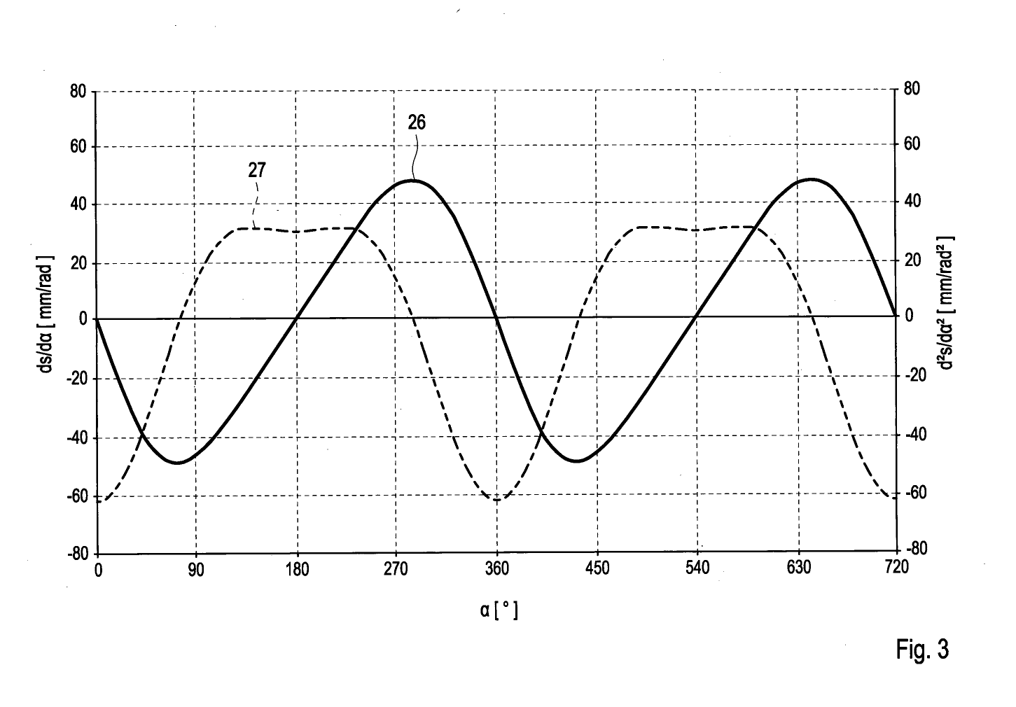

FIG. 3 a diagram in which the piston speed and the piston acceleration are plotted over the crankshaft angle for a conventional crankshaft drive and

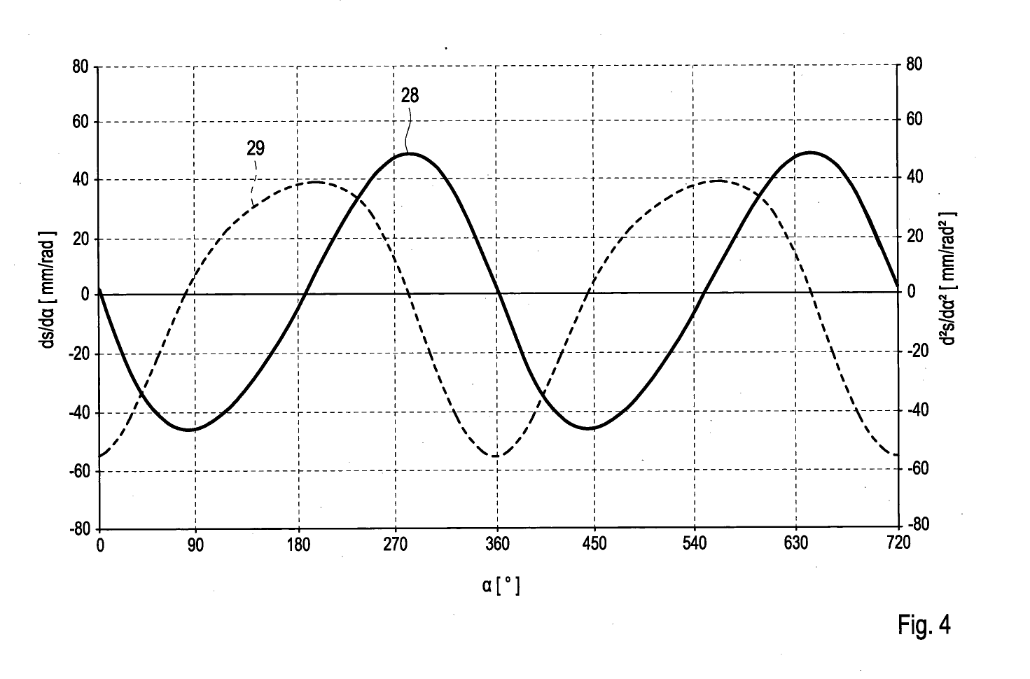

FIG. 4 a diagram in which the piston speed and the piston acceleration are plotted over the crankshaft angle for the multi-joint crankshaft drive.

FIG. 1 shows a perspective view of a region of an internal combustion engine 1, which is for example constructed as in-line internal combustion engine, in particular as four-stroke four-cylinder in-line internal combustion engine. The internal combustion engine 1 has a crankshaft 2 and multiple pistons 3 (here: four pistons 3), each of which is movably supported in one of multiple cylinders of the internal combustion engine 1. Each of the pistons 3 is connected with the crankshaft 2 via a piston connecting rod 4. The crankshaft 2 is rotatably supported in here not shown shaft bearings of an also not shown cylinder crankcase of the internal combustion engine 1, and has for example multiple central shaft pins 5 for support and multiple crankpins 6 (of which only one is visible in the Figure) whose longitudinal center axes are offset in different angular orientations parallel to a rotation axis 7 of the crankshaft 2.

The internal combustion engine 1 further includes an eccentric shaft 8, which preferably has a rotation axis 9, which is parallel to the rotation axis 7 of the crankshaft 2. The eccentric shaft 8 is for example rotatably supported adjacent the crankshaft 2 and above the crankshaft 2 in the cylinder crankcase and is in particular coupled with the crankshaft 2. Particularly preferably the eccentric shaft 8 is arranged so that its rotation axis 9 is situated above a plane, which receives the rotation axis 7 of the crankshaft 2 and is perpendicular to at least one cylinder longitudinal center axis of one of the cylinders of the internal combustion engine 1.

The eccentric shaft 8 is a part of a multi-joint crank drive 10. The latter additionally has multiple coupling members 11 (here: four coupling members 11), which are each rotatably supported on one of the crankpins 6 of the crankshaft 2. Preferably such a coupling member 11 is assigned to each of the pistons 3. The coupling members 11 each have a lift arm 12, which is pivotally connected with a lower end of one of the piston connecting rods 4 via a pivot joint 13. An upper end of the respective piston connecting rod 4 is articulately connected on the associated piston 3 via a further pivot joint 14. Overall each of the pistons 3 is thus connected with the crankshaft 2 by the respective piston connecting rod 4 and the respective coupling member 11.

The multi-joint crank drive 10 further includes a number of articulated connecting rods 15 which corresponds to the number of piston connecting rods 4 and the coupling members 11. The articulated connecting rods are for example oriented approximately parallel to the piston connecting rids 4 and arranged in axial direction of the crankshaft 2 and the eccentric shaft 8 in about the same plane as the associated piston connecting rod 4, but on the opposite side of the crankshaft 2. Each articulated connecting rod 15 includes a connecting rod body 16 and two conrod eyes 17 and 18, in particular with different inner diameters, arranged on opposite ends of the connecting rod body 16.

The conrod eye 18 of each articulated connecting rod 15 at the lower end of the connecting rod body 16 surrounds a crankpin 19 of the eccentric shaft 8, which crankpin is eccentric in relation to the rotation axis 9 of the eccentric shaft 8 and on which crankpin the articulated connecting rod 15 is rotatably supported by means of a rotary bearing 20. The conrod eye 17 at the upper end of the connecting rod body 16 of each articulated connecting rod 15 forms a part of the pivot joint 21 between the articulated connecting rod 15 and a longer coupling arm 22 of the neighboring coupling member 11, which protrudes over the crankshaft 2 on the side of the crankshaft which is opposite to the lift arm 12. The conrod eye 18 is for example greater than the conrod eye 17; the multi-joint crank dive 10 can however also be realized in the opposite manner or with conrod eyes 17 and 18 of the same size.

Between neighboring crankpins 19 and at its front ends, the eccentric shaft 8 has coaxial shaft sections 23, which serve for support of the eccentric shaft 8 in shaft bearings and which are coaxial to the rotation axis 10. Beside enabling a variable compression the described arrangement also allows reducing the incline of the piston connecting rods 4 in relation to the cylinder axis of the associated cylinders during rotation of the crankshaft 2, which leads to a decrease of the piston side-forces and with this the friction forces between the piston 2 and the walls of the cylinders.

Overall, the herein described multi-joint crank drive 10 enables selecting or adjusting an working stroke of the pistons in dependence of a current operating cycle of the internal combustion engine. For example the eccentric shaft 8 is for this purpose driven by the crankshaft 2 via a here not shown eccentric shaft drive. The eccentric shaft drive includes at least one transmission element (not shown) arranged on the eccentric shaft 8.

FIG. 2 shows a diagram in which a piston lift s in the unit mm is plotted over the crankshaft angle a in the unit degrees with a course 24 for a piston in a conventional crank drive and with a course 25 for a piston in the multi-joint crank drive 10. In the case of the latter the multi-joint crank drive 10 is configured or adjusted so that a crankshaft rotary angular range of an intake phase is greater than 180 degrees, that a crankshaft rotary angular range of a compression phase is smaller than 180 degrees, that a crankshaft rotary angular range of an expansion phase is greater than 180 degrees and that a crankshaft rotary angular range of an exhaust phase is smaller than 180 degrees.

FIG. 3 shows a diagram for a normal crankshaft drive, in which a course 26 represents the piston speed ds/da in the unit mm/rad and a course 27 represents the piston speed d²s/da² in the unit mm/rad², each plotted over the crankshaft angle α.

FIG. 4 on the other hand shows a diagram which for the multi-joint crank drive shows the piston speed ds/da in a course 28, and in a course 29 the piston acceleration d²s/da², each also plotted over the crankshaft angle α. The comparison of FIGS. 3 and 4 shows that the piston speed for the multi-joint crank drive 10 in crankshaft rotary angular ranges about the crankshaft angle 270 degrees and 630 degrees decreases compared to the normal crank drive. The inflection points of the speed course in these crankshaft rotary angular ranges are shifted towards lower crankshafts. Because the (absolute) piston accelerations approximate each other in an upper dead center position and a lower dead center position, the second order inertia forces significantly decrease.

By means of the described multi-joint crank drive 10 of the internal combustion engine 1 the second order inertia forces can thus be positively influenced. This improves the calm running of the internal combustion engine 1, for which merely the lifting curves, i.e., the course of the piston lift over the crankshaft angle, are slightly changed.

### LIST OF REFERENCE SIGNS

1 internal combustion engine

2 crankshaft

3 piston

4 piston connecting rod

5 shaft pin

6 crankpin

7 rotation axis

8 eccentric shaft

9 rotation axis

10 multi-joint crank drive

11 coupling member

12 cylinder capacity

13 pivot joint

14 pivot joint

15 articulated connecting rod

16 connecting rod body

17 conrod eye

18 conrod eye

19 crankpin

20 rotary bearing

21 pivot joint

22 coupling arm

23 shaft section

24 course

25 course

26 course

27 course

28 course

29 course

1.-10. (canceled)

11. A multi-joint crank drive of an internal combustion engine for adjusting a compression ratio achieved in a cylinder assigned to a respective one of plural pistons of the internal combustion engine, said multi-joint crank drive comprising:
a plurality of coupling members rotatably supported on crankpins of a crankshaft; and
a plurality of articulated connecting rods rotatably supported on crankpins of an eccentric shaft, each of said coupling members being pivotally connected with a piston connecting rod of a piston of the internal combustion engine and one of the articulated connecting rods, wherein for adjusting the compression ratio to a desired compression ratio the eccentric shaft is movable into an angular position corresponding to the desired compression ratio, and wherein for reducing second order inertia forces the multi-joint crank drive is configured or adjusted so that
a crankshaft rotary angular range of an intake phase is greater than 180 degrees,
a crankshaft rotary angular range of a compression phase is smaller than 180 degrees,
a crankshaft rotary angular range of an expansion phase is greater than 180 degrees, and
a crankshaft rotary angular range of a exhaust phase is smaller than 180 degrees.

12. The multi-joint crank drive of claim 1, wherein a rotation axis of the eccentric shaft and the pistons are situated on a same side of a plane, which receives a rotation axis of the crankshaft and which is perpendicular to at least one cylinder longitudinal center axis.

13. The multi-joint crank drive of claim 11, wherein the crankshaft (2) has a crank angle of 180 degrees.

14. The multi-joint crank drive of claim 11, wherein in the intake phase an upper dead center position is present at a crankshaft angle of greater than 0 degrees and at most 4 degrees.

15. The multi-joint crank drive of claim 11, wherein in the compression phase a lower dead center position is present at a crankshaft angle of greater than 180.

16. The multi-joint crank drive of claim 11, wherein in the expansion phase an upper dead center position is present at a crankshaft angle of greater than 360 degrees and at most 364 degrees.

17. The multi-joint crank drive of claim 11, wherein in the exhaust phase a lower dead center position is present at a crankshaft angle of greater than 540 degrees.

18. The multi-joint crank drive of claim 11, wherein the crankshaft angular ranges of the intake phase and compression phase and/or the crankshaft angular ranges for the expansion phase and the exhaust phase in sum are equal to 360 degrees.

19. A method for operating a multi-join crank drive of an internal combustion engine for adjusting a compression ratio achieved in a cylinder assigned to a respective one of plural pistons of the internal combustion engine, comprising:
providing multi-joint crank drive comprising a plurality of coupling members rotatably supported on crankpins of a crankshaft, and a plurality of articulated connecting rod rotatably supported on crankpin of an eccentric shaft, each said coupling members being pivotally connected with a piston connecting rod of a piston of the internal combustion engine and one of the articulated connecting rod;
adjusting the compression ratio achieved in the cylinder assigned to the respective one of the plural pistons to a desired compression ratio by moving the eccentric shaft into an angular position corresponding to a desired compression ratio; and
reducing second order inertia forces by adjusting the multi-joint crank drive in at least one operating mode so that
a crankshaft rotary angular range of an intake phase is greater than 180 degrees,
a crankshaft rotary angular range of a compression phase is smaller than 180 degrees,
a crankshaft rotary angular range of an expansion phase is greater than 180 degrees, and
a crankshaft rotary angular range of a exhaust phase is smaller than 180 degrees.

20. The method of claim 19, further comprising adjusting the multi-joint crank drive in at least one further operating mode so that the crankshaft rotary angular range of the intake phase is different from the first value, in particular equal to 180 degrees, and/or that the crankshaft rotary angular range of the compression phase is different from the second value, in particular equal to 180 degrees, and/or that the crankshaft rotary angular range of the expansion phase is different from the third value, in particular equal to 180 degrees, and/or that the crankshaft rotary angular range of the exhaust phase is different from the fourth value, in particular equal to 180 degrees.
